(19) United States
(12) Patent Application Publication
(10) Pub. No.: US 2026/0252932 A1
(43) Pub. Date: Aug. 27, 2026

(54) FUSION BASED ROUTING ON QUANTUM COMPUTERS

(71) Applicant: IonQ Quantum Canada, Inc., Toronto (CA)

(72) Inventor: Edwin THAM, Toronto (CA)

(21) Appl. No.: 19/551,155

(22) Filed: Feb. 26, 2026

Related U.S. Application Data
(60) Provisional application No. 63/764,422, filed on Feb. 27, 2025.

(51) Int. Cl. G06N 10/20

(52) U.S. Cl. CPC G06N 10/20

(57) ABSTRACT

Aspects of the present disclosure relate generally to systems and methods for use in the implementation and/or operation of quantum information processing (QIP) systems, and more particularly, to ion entanglement. Some examples include generating a fused resource-state between atomic qubits of non-neighboring parcels such that the atomic qubit share a Bell state.

### CROSS REFERENCE TO RELATED APPLICATIONS

This application claims priority to U.S. Provisional Patent Application No. 63/764,422, filed February 27, 2025, the entire contents of which are hereby incorporated by reference.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Other implementations include those based on superconducting qubits or photonic qubits, for example. Atomic-based qubits may be used as quantum memories, to perform quantum gates in quantum computers and simulators, and may act as nodes for quantum communication networks. Qubits based on trapped atomic ions enjoy a rare combination of attributes. For example, qubits based on trapped atomic ions have long coherence time properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

Single-chain trapped ion quantum computers boast all-to-all qubit connectivity, substantially simplifying quantum circuit compilation and low-overhead qubit routing. However, scaling of quantum computers will likely introduce multi-chain reconfigurable modular quantum architecture (RMQA) or even multi-node photonic interconnect (PI) architectures to current single-chain systems. Scaling up to these architectures breaks all-to-all qubit connectivity. On RMQA especially, shuttling of ion(s) between chains is a slow costly process, and chain-to-chain connectivity may be limited to nearest-neighbor only in some trap architectures. This is an especially acute problem on large architectures with many chains or nodes.

Compiler research has resulted in varying degrees of improvement in utilization of limited-connectivity architecture. Notably, prior work had studied the use of ancilla qubits to facilitate routing on-demand. However, no work to date addresses the issue of slow shuttling and interconnect operation that hinder use of techniques like the afore-mentioned ancilla-assisted routing.

It is therefore important to develop new techniques that improve the connectivity of qubits in modular or distributed architectures, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of methods and systems for performing computations in a quantum computing system. Aspects related to a method of performing quantum operations in a quantum system, comprising: a) providing a trap comprising a plurality of parcels of atomic qubits, wherein the plurality of parcels includes a first parcel, a distant parcel that is not neighboring to the first parcel, and at least one intervening parcel; b) configuring a shared Bell state between at least one atomic qubit of each parcel of each pair of neighboring parcels in the trap; c) in each intervening parcel including two atomic qubits having a shared Bell state with an atomic qubit of a neighboring parcel, configuring a shared Bell state between the two atomic qubits; and d) generating a fused resource-state between an atomic qubit of the first parcel and an atomic qubit of the distant parcel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings provided to illustrate and not to limit the disclosed aspects, wherein like designations denote like elements, and in which.

FIG. 1 illustrates a view of atomic ions in a linear crystal or chain, in accordance with exemplary aspects of the disclosure.

FIG. 2 illustrates an example of a quantum information processing (QIP) system, in accordance with exemplary aspects of the disclosure.

FIG. 3 illustrates an example of a computer device, in accordance with exemplary aspects of the disclosure.

FIG. 4 illustrates an example of a QPU network according to aspects of the present disclosure.

FIGS. 5A-5F illustrate steps of an exemplary fusion routing method.

FIG. 6. illustrates a flowchart of a fusion routing method according to an exemplary aspect.

### DETAILED DESCRIPTION

Quantum computing is a method for processing information that utilizes quantum bits (qubits) as the fundamental unit of information storage. QC furthermore leverages entanglement between qubits to perform computations with fewer resources (e.g. computation time, number of bits, etc.) than classical computing schemes. Within a quantum computer, quantum processing units (QPUs) can be apportioned by the subset(s) of qubits between which entanglement can be deterministically generated and thereby quantum gates carried out directly. Building large QPUs may be a challenging task with numerous technical obstacles specific to the particular quantum system used as a platform for the computation.

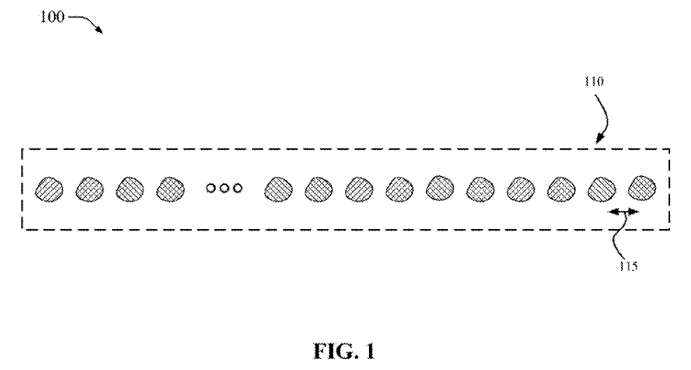

Solutions to the issues described above are explained in more detail in connection with FIGS. 1-9, with FIGS. 1-3 providing a background of QIP systems or quantum computers, and more specifically, of atomic-based QIP systems or quantum computers.

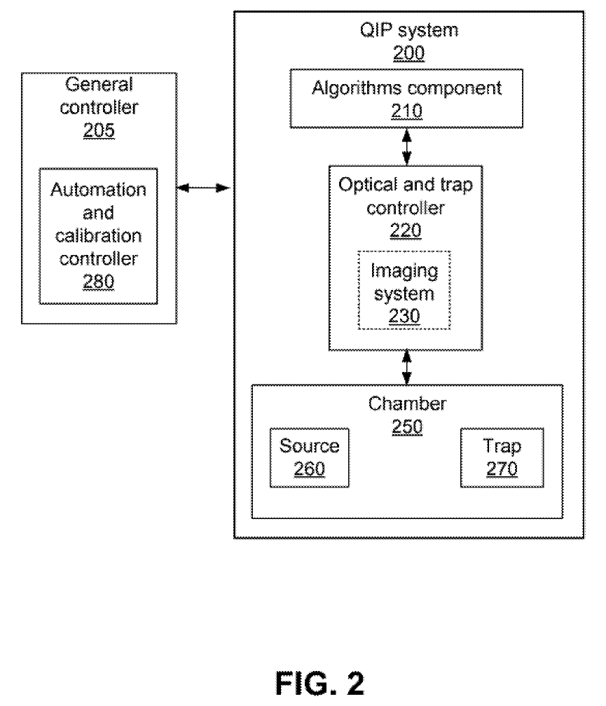

FIG. 1 shown below illustrates a diagram 100 with multiple atomic ions 106 (e.g., atomic ions 106a, 106b, ..., 106c, and 106d) trapped in a linear crystal or chain 110 using a trap (the trap can be inside a vacuum chamber as shown in FIG. 2 or inside a plurality of nested vacuum chambers). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110. While some examples utilize atomic ions as atomic qubits as shown in FIG. 1, in some examples, each one of the atomic qubits can be a neutral atom.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. In some examples, the trap may trap 32, 64, 96, 128 or any other configuration or number of ions. In some examples, the trap may emit electrical fields (e.g., electromagnetic, electrostatic, etc.) in a predetermined configuration that organize a plurality of ions into one or more ion chains in a single ion trap.

Suitable atomic ions include but are not limited to Ytterbium ions (e.g., 171Yb+ ions) or Barium ions (e.g., 133Ba+ ions), for example. The atomic ions are illuminated with laser (optical) radiation tuned to a resonance corresponding to the desired atomic ion (e.g., 171Yb+) and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and may or may not be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations, and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250 or otherwise positioned to allow the optical beams to interact with the ions in the trap. For example, optical systems within the chamber 250 may refer to optical components or optical assemblies. Additionally, in some examples, the chamber 250 may comprise a plurality of nested vacuum chambers, such as an interior vacuum chamber positioned inside of another vacuum chamber.

In some examples, the optical and trap controller 220 may include a Raman system (not shown), such as but not limited to the Raman system for double individual-addressing of the ions in the trap as disclosed in US20240022335, the entirety of which is incorporated by reference herein. Briefly, a suitable Raman system may include a first multi-channel modulator (MCM), a first telecentric zoom lens, and a first interleaver that with one or more optical components form a first optical path of the Raman system and are configured to receive a first array of beams and to adjust the first array of beams for each beam in the first array of beams to individually address a respective atomic-based qubit in a chain from a first direction; and a second MCM, a second telecentric zoom lens, and a second interleaver that with one or more optical components form a second optical path of the Raman system and are configured to receive a second array of beams and to adjust the second arrays of beams for each beam in the second array of beams to individually address a respective atomic-based qubit in the chain from a second direction different from the first direction. Such a Raman system as described is advantageously capable of effecting a desired quantum gate operation by targeting a specific qubit or pairs of qubits in a linear array or chain of qubits (e.g., ions) by turning on one or two AOM (acousto-optic modulator) channels on the multi-channel AOM. Quantum gates requiring more than two qubits can be realized by turning on more AOM channels in the multi-channel AOM.

In other implementations, the QIP system 200 can include solid-state devices of one of several types. Such devices can be embodied in, for example, Josephson junction devices, semiconductor quantum-dots, defects in a semiconductor material (such as vacancies in Si and Ge, or nitrogen-vacancy centers in diamond or silicon carbide), or electron spin centers in semiconductors (doped or intrinsic). Superconducting qubits and spin qubits can be individually addressable by microwave electromagnetic radiation.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210.

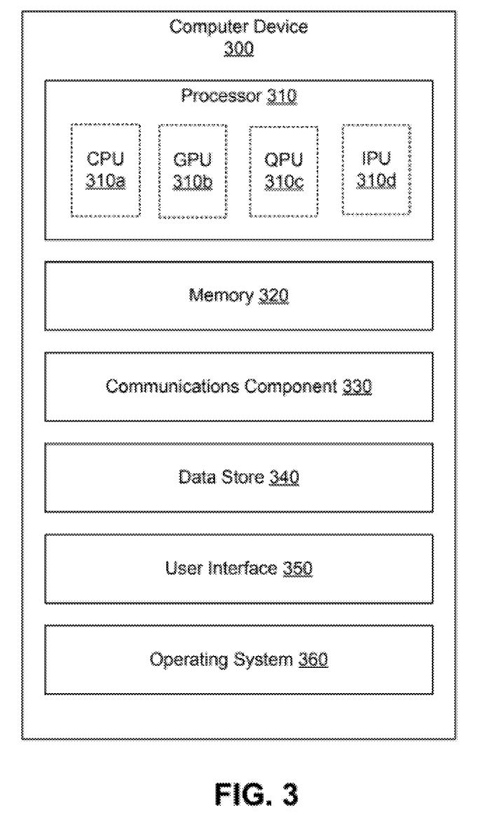

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

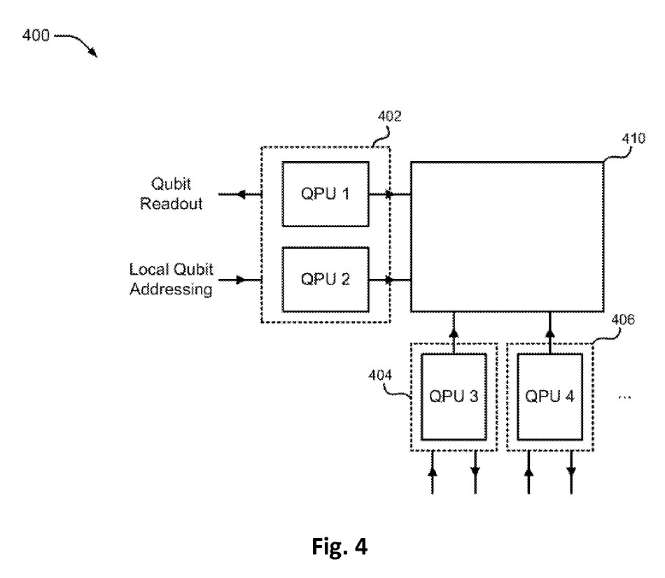

FIG. 4 illustrates an example of a QPU network 400 according to aspects of the present disclosure. Individual atoms confined in single or multi-dimensional arrays within a vacuum chamber may provide a promising platform for QC that also lends itself to an interconnected QPU network. Proposals for interconnecting atomic qubits probabilistically herald entanglement between “distant” atoms (i.e. ones that do not interact directly) upon detection of photons emitted from each atom. Thus, for interconnect operations in a multi-QPU QC architecture, the interconnect attempt may be repeated.

In some aspects, the QPU network 400 may include a first vacuum chamber 402 having a first processor QPU 1 and a second processor QPU 2. The QPU network 400 may include a second vacuum chamber 404 having a third processor QPU 3 and a fourth vacuum chamber 406 having a fourth processor QPU 4. Other numbers of vacuum chamber and/or processors may also be implemented. The QPU network 400 may include an interconnect system 410, such as an optical switch, configured to provide one or more paths for entangling the qubits in any combination of the processors QPU 1, QPU 2, QPU 3, QPU 4 as described below.

In certain aspects, implementing remote entanglement across QPUs in a QPU network may require collecting photons from atoms in distinct QPUs, which are not necessarily situated in the same vacuum chamber (as shown in FIG. 1). By manipulating a qubit (communication qubit) from each of a pair of distant QPUs, respectively, the pair of communication qubits can be entangled by each communication qubit emitting photons that interfere with each other. Entanglement generated between the “communication qubits” can be utilized as a resource to perform a two-qubit gate between any pair of qubits each QPU using local qubit gates, measurements, and classical communication between the QPUs.

Aspects of this disclosure relate to a method of performing quantum operations in a quantum system, comprises: a) providing a trap comprising a plurality of parcels of atomic qubits, wherein the plurality of parcels includes a first parcel, a distant parcel that is not neighboring to the first parcel, and at least one intervening parcel; b) configuring a shared Bell state between at least one atomic qubit of each parcel of each pair of neighboring parcels in the trap; c) in each intervening parcel including two atomic qubits having a shared Bell state with an atomic qubit of a neighboring parcel, configuring a shared Bell state between the two atomic qubits; and d) generating a fused resource-state between an atomic qubit of the first parcel and an atomic qubit of the distant parcel.

According to an exemplary aspect, a “shared Bell state” can refer to a two-qubit entangled state, also known as a two-qubit resource-state, which is configured between a pair of atomic qubits. A shared Bell state may be configured between atomic qubits residing in the same parcel or in different parcels in exemplary aspects. As described in further detail below, shared Bell states configured between atomic qubits of neighboring parcels, and shared Bell states configured between two atomic qubits within the same intervening parcel, serve as intermediate entangled states in a fusion process. In the exemplary aspect, these intermediate shared Bell states can each span a single pair of neighboring parcels or a single intervening parcel and individually do not provide entanglement connectivity between non-neighboring parcels such as a first parcel and a distant parcel.

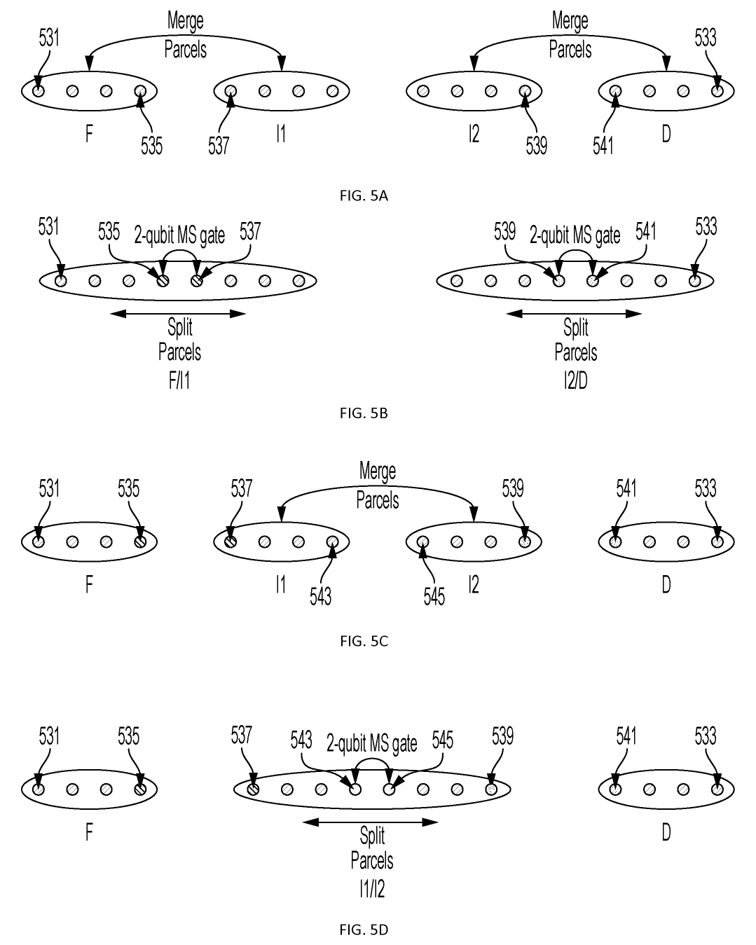

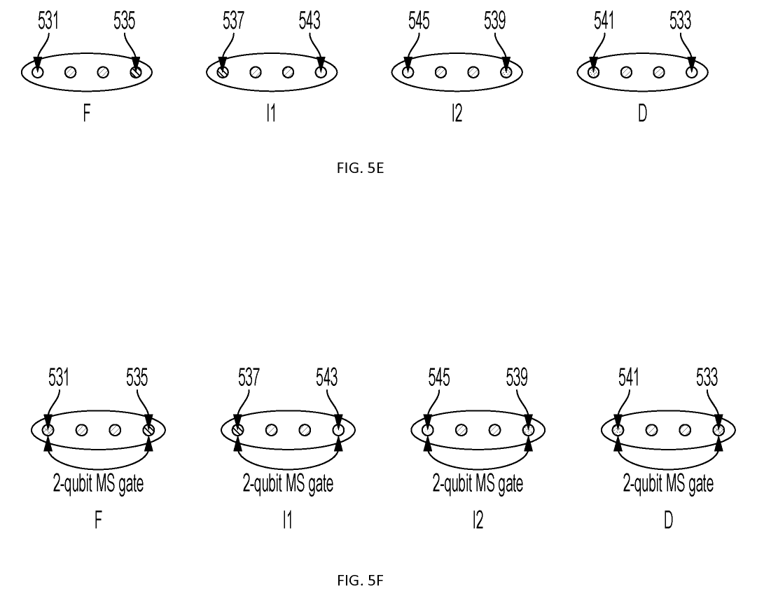

Moreover, according to an exemplary aspect, a “fused resource-state” can refer to a Bell state that results from the fusion of two or more of the intermediate shared Bell states described above and that spans non-neighboring parcels, such as a first parcel and a distant parcel, thereby providing direct entanglement connectivity between atomic qubits of those non-neighboring parcels. Unlike the intermediate shared Bell states, which individually connect only neighboring parcels or qubits within a single intervening parcel, the fused resource-state can be a single output Bell state produced by performing two-qubit gate operations, measurements, and conditioned single-qubit gate corrections on the atomic qubits of the intervening parcels that hold the intermediate shared Bell states, as described below in connection with FIGS. 5A–5F. The fused resource-state may subsequently be used to perform long-range logical operations, such as teleportation or remote CNOT gates, between atomic data qubits of the non-neighboring parcels it connects.

It is also noted that according to an exemplary aspect, a fused resource-state can be generated by a specific sequence of quantum operations performed on the atomic qubits of the intervening parcels. As described in connection with FIG. 5F, in each intervening parcel that includes two atomic qubits each sharing a Bell state with an atomic qubit of a respective neighboring parcel, the fusion process comprises: (i) performing a two-qubit gate operation (e.g., a Mølmer-Sørensen gate) between those two atomic qubits within the intervening parcel; (ii) measuring the states of those two atomic qubits; and (iii) conditioned upon the measurement outcomes, applying single-qubit gate corrections to the endpoint atomic qubits of the first parcel and the distant parcel that were not measured. Upon completion of these operations across all intervening parcels, the endpoint atomic qubits of the first parcel and the distant parcel are left in a shared Bell state that forms the fused resource-state. According to various exemplary aspects, the two-qubit gate operations, measurements, and conditioned single-qubit gate corrections in the intervening parcels may be performed simultaneously in parallel or sequentially, and the fusion process may be accomplished in as few as two layers of gates.

In general, it is noted that the methods and systems disclosed herein allow any given hardware architecture to trade space (e.g. extra qubits) used to store pre-defined quantum “resource-states”, in exchange for much improved qubit routing time when the underlying hardware has limited qubit connectivity. Qubits based on trapped atomic ions can have very good coherence properties, can be prepared and measured with nearly 100% efficiency, and can be readily entangled with each other by modulating their Coulomb interaction with suitable external control fields such as optical or microwave fields. Examples of entangling gate operations are described in U.S. Patent No. 11,157,826, which is incorporated in its entirety herein by reference.

The disclosed methods and systems rely on the observation that multiple copies of a two-qubit resource-state (i.e. “Bell states”) spanning a set of qubits can be “fused” efficiently and subsequently used for qubit routing. The qubits holding these Bell states can span many chains or nodes, possibly mutually distant chains or nodes, and may otherwise require significant shuttling to be brought into proximity to each other. The fusion process is efficient and can be accomplished in at most two timesteps (i.e. two layers of gates). The outcome of a round of fusion is a single output Bell state that connects the two specific chains/nodes required by a user application.

As a concrete example, underlying hardware connectivity may allow a user to create three Bell states spanning nodes A-B, B-C, and C-D; then, fusion can produce a lone Bell state that spans parcels A-D directly. That final Bell state can then be used to teleport or realize remote gates between A and D even if those nodes are distant.

Aspects of this disclosure may use a protocol as described herein on a 1D Reconfigurable Multicore Quantum Architecture (RMQA)-based nearest-neighbor architecture. Some aspects may include a trapped-ion device with many qubit chains each approximately two to one-hundred ions in length, laid out on a 2D square grid. Each chain may be brought into contact with a neighboring chain, via a shuttling process. Each time two neighboring chains are brought into contact, a number of gates and qubits are devoted to creating and holding Bell states spanning those parcels. This is done opportunistically, and a single (slow) shuttle can yield many such Bell states, limited only by the number of spare qubits one is willing to devote to the process. By maintaining Bell states spanning all nearest-neighbor chains, qubit routing becomes much more efficient. In fact, on an N-chain device, simply maintaining O(sqrt(N)) Bell pairs per chain guarantees any set of routing operation can occur in just O(1) time. The specific choice of how many Bell pairs to maintain and in what pattern can be flexibly optimized based on the user-application.

A similar protocol can be utilized in PI systems, especially if the cost and complexity of building large photon-routing hardware (e.g. switch and routable Bell-state analyzers) is prohibitive.

FIGS. 5A-5F depict a schematic of an exemplary method of performing quantum operations in a quantum system. It should be appreciated that the method shown in FIG. 5 is merely an example and that contemplated embodiments may include repetition of one or more steps or may include additional steps. FIGS. 5A-5F schematically depict an ion trap comprising a plurality of parcels of atomic qubits (also sometimes referred to as “cores”). As shown, each parcel contains one or more qubits, such as trapped ions, neutral atoms or other qubit types. The number of qubits in each parcel is arbitrary and may differ from parcel to parcel. Additionally, the number of qubits in each parcel is flexible and may be changed by shuttling qubits to or from any parcel. Examples of shuttling qubits are described in US Pat. No. 11,281,987, which is incorporated herein in its entirety by reference.

As shown in FIG. 5A, the plurality of parcels includes a first parcel F, a distant parcel D, and at least one intervening parcel I (individually, I1, I2, etc.). The number of intervening parcels may be selected from any integer of 1 or more. The first parcel F comprises a first atomic qubit 531 and the distant parcel D comprises a distant atomic qubit 533. While FIG. 5A identifies a specific qubit of the parcels as the first atomic qubit 531, or distant atomic qubit 533, for example, it should be understood that any qubit of the respective parcels may serve as the operative qubits. The parcels may be arranged in respective control units as described in US Pat. No. 11,281,987, which is incorporated herein in its entirety by reference.

The first parcel F neighbors intervening parcel I1, but not intervening parcel I2 or distant parcel D. As shown, in FIGS. 5A-D the intervening parcel I2 may be neighboring to distant parcel D and intervening parcel I1, but not neighboring to first parcel F. Additionally, while the architecture shown in FIGS. 5A-D is simplified as a linear architecture, the methods and systems disclosed herein are applicable to other trap architectures, such as a 2D grid architecture.

FIGS. 5A-5D depict an exemplary process of configuring a shared Bell state between at least one atomic qubit of each parcel of each pair of neighboring parcels in the trap as shown in FIG. 5E. From such a configuration, as shown in FIG. 5F, a fused-resource state between qubits of the first parcel F and distant parcel D may be obtained.

In FIG. 5B, a shared Bell state may be configured between an atomic qubit 535 of the first parcel F and an atomic qubit 537 of intervening parcel I1 neighboring to the first parcel. Also in FIG. 5B, a shared Bell state may be configured between an atomic qubit 539 of the intervening parcel I2 and an atomic qubit 541 of neighboring to the distant parcel D.

The shared Bell states may be achieved by a two-qubit gate operation, such as a Mølmer-Sørenson gate although any qubit entangling gate operation is suitable. As shown in FIG. 5B, the first parcel F and intervening parcel I1 may be “merged” into a combined parcel as shown as “F/I1” to implement the gate operation between qubits of different parcels. Likewise, the intervening parcel I2 and distant parcel D may be “merged” into a combined parcel as shown as “I2/D” to implement the gate operation.

In FIG. 5C, the merged parcels “F/I1” and “I2/D” have been separated such that the first parcel F, distant parcel D, and intervening parcels I1, I2 are individual parcels. As shown, the first parcel F and intervening parcel I1 respectively include entangled qubits pair 535 and 537, whereas the intervening parcel I2 and the distant parcel D respectively include entangled qubit pair 539 and 541. The entangled states are preferably maintained.

In FIG. 5D, intervening parcels I1 and I2 have been merged into a combined parcel as shown as “I1/I2” to implement a gate operation. A shared Bell state may be configured between an atomic qubit 543 of the intervening parcel I1 and atomic qubit 545 of intervening parcel I2 while intervening parcels I1 and I2 are merged. Similarly, as noted above, each shared Bell state between qubits of different parcels may be achieved by a two-qubit gate operation, such as a Mølmer-Sørenson gate while respective parcels are “merged.”

In FIG. 5E, a shared Bell state has been configured between at least one atomic qubit of each parcel of each pair of neighboring parcels in the trap. Specifically, in the pair of neighboring parcels F and I1, qubits 535 and 537 share a Bell state; in the pair of neighboring parcels I1 and I2, qubits 543 and 545 share a Bell state; and in the pair of neighboring parcels I2 and D, qubits 539 and 541 share a Bell state. The entangled states are preferably maintained.

In FIG. 5F, in each intervening parcel including two atomic qubits having a shared Bell state with an atomic qubit of a neighboring parcel, a shared Bell state is configured between the two atomic qubits. In the example shown, intervening parcel I1 includes two atomic qubits (537 and 543) having a shared Bell state with an atomic qubit of a neighboring parcel, namely, qubit 537 has a shared Bell state with qubit 535 of the first parcel F, and qubit 543 has a shared Bell state with qubit 545 of intervening parcel I2. Likewise, intervening parcel I2 includes two atomic qubits (545 and 539) having a shared Bell state with an atomic qubit of a neighboring parcel, namely, qubit 545 has a shared Bell state with qubit 543 of the intervening parcel I1, and qubit 539 has a shared Bell state with qubit 541 of distant parcel D. The two atomic qubits (537 and 543) of intervening parcel I1 are subjected a two-qubit gate operation, such as a Molmer-Sorenson gate between atomic qubits 537 and 543, as well as between atomic qubits 545 and 539. Following that, the same atomic qubits may be measured and conditioned upon those measurement outcomes, single-qubit gates may be applied to atomic qubits 535 and 541, whereupon, atomic qubits 535 and 541 (which did not previously share a Bell-state) now have a shared Bell-state.

Also shown in FIG. 5F, is the utilization of the resulting long-range Bell-state that resides within atomic qubits 535 and 541 connecting parcels F and D, to realize long-range logical operations such as teleportation and CNOT gates for atomic data qubits 531 and 533. Realizing that long-range logical operation requires only two-qubit gates, such as a Molmer-Sorenson gate local to a parcel (between qubits 533 and 541 in parcel D, and 531 and 535 in parcel F) connecting the target data qubits to that long-range Bell-state.

In some aspect of this disclosure, some or all of the gate operations depicted in FIG. 5F may be performed simultaneously in parallel gate operations. In other examples, some or all of the gate operations may be performed sequentially.

The fused resource-state may be maintained for a period of time as desired to reserve or “store” a connection between qubits of non-neighboring parcels as needed for future calculations.

Advantageously, by methods according to this disclosure, generating a fused resource-state between the first atomic qubit and the distant atomic qubit may be accomplished with as few as N-1 of gates, where N is the number of parcels, and in as few as two steps of parcel merging.

Some aspects of this disclosure may include configuring an atomic qubit of a further trap to share a Bell state with the distant atomic qubit of the distant parcel. As described in detail in U.S. Patent No. 9,858,531, which is incorporated herein by reference in its entirety, modular quantum computer architectures may include a plurality of modular elementary logic units (ELUs), each modular ELU housing a plurality of stationary matter qubits in a trap, interconnected by a photonic interconnect network. Local entangling quantum gates between qubit within a single trap register are accomplished using natural interactions between the qubits, and entanglement between separate modular registers is completed via a probabilistic photonic interface between qubits in different registers, even over large distances.

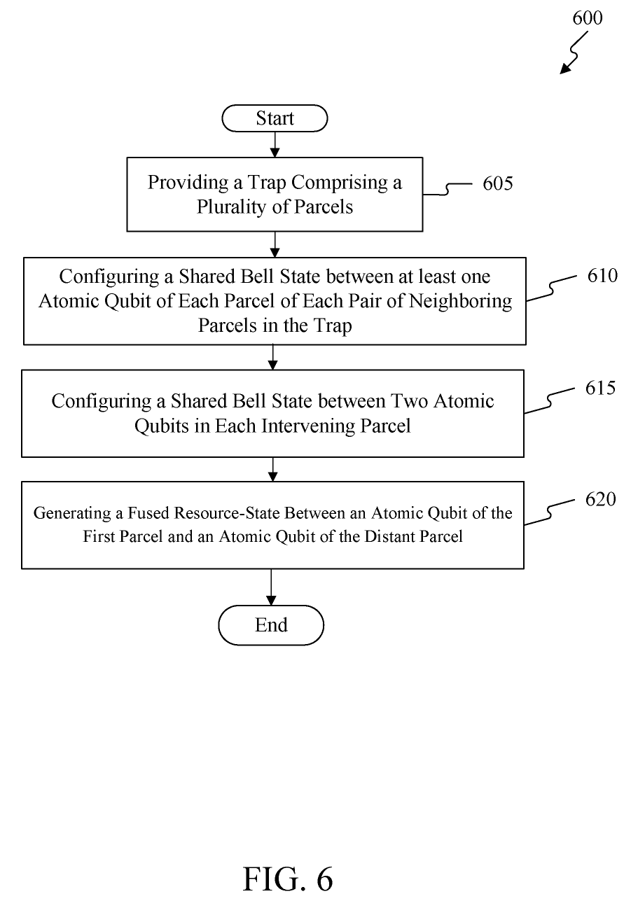

FIG. 6. illustrates a flowchart of a fusion routing method according to an exemplary aspect. In general, the flow chart of method 600 shown in FIG. 6 corresponds to one or more of the quantum operations in a quantum system shown in FIGS. 5A-5F and described above. As shown, the method 600 starts at step 605 in which a trap is provided or otherwise configured to have a plurality of parcels of atomic qubits. An example ion trap 270 is shown in FIG. 2 and described above, and can include a plurality of qubits as generally shown in FIG. 1. Moreover, parcels of qubits generally each include one or more qubits, such as trapped ions, neutral atoms or other qubit type. At step 605, the ion trap is configured such that the plurality of parcels includes a first parcel, a distant parcel that is not neighboring to the first parcel, and at least one intervening parcel.

Next, at step 610, the method includes configuring a shared Bell state between at least one atomic qubit of each parcel of each pair of neighboring parcels in the trap as described above. An example of this step is shown in FIG. 5B and described above.

Then, at step 615, in each intervening parcel including two atomic qubits having a shared Bell state with an atomic qubit of a neighboring parcel, the method includes configuring a shared Bell state between the two atomic qubits. An example of this step is shown in FIGS. 5C and/or 5D and described above. Finally, at step 620, the method includes generating a fused resource-state between an atomic qubit of the first parcel and an atomic qubit of the distant parcel. As described above, the method disclosed herein enables the generating of a fused resource-state between the first atomic qubit and the distant atomic qubit that may be accomplished with as few as N-1 of gates, where N is the number of parcels, and in as few as two steps of parcel merging.

Aspects of this disclosure relate to a quantum system configured to perform quantum operations, comprising a trap comprising a plurality of parcels of atomic qubits, wherein the plurality of parcels includes a first parcel, a distant parcel that is not neighboring to the first parcel, and at least one intervening parcel and an optical controller. The optical controller may be configured to: implement a shared Bell state between a first atomic qubit of the first parcel and an atomic qubit of an intervening parcel neighboring to the first parcel; and implement a copy of the shared Bell state between the atomic qubit of the intervening parcel neighboring to the first parcel and a distant atomic qubit of a distant parcel; and generate a fused resource-state between an atomic qubit of the first parcel and an atomic qubit of the distant parcel such that the atomic qubits of the first parcel and the distant parcel share a Bell state.

In general, it is noted that according to exemplary aspects, two parcels are considered “neighboring” parcels when they are capable of being merged or otherwise brought into direct physical contact with one another such that a two-qubit gate operation (e.g., a Mølmer-Sørensen gate) can be performed between an atomic qubit of one parcel and an atomic qubit of the other parcel. Conversely, a parcel is “distant” or “not neighboring” to another parcel when it cannot be directly merged with that parcel for a gate operation without first traversing one or more intervening parcels. While FIGS. 5A–5F illustrate a simplified linear architecture, the methods and systems disclosed herein are applicable to other trap architectures, including a 2D grid architecture according to various exemplary aspects. In such a 2D grid architecture, for example, each parcel may have up to four neighboring parcels (e.g., one in each of the above, below, left, and right directions), with which it may be merged via a shuttling process to perform a two-qubit gate operation. In such a 2D grid architecture, a first parcel located at one position in the grid and a distant parcel located at a non-adjacent position would be separated by one or more intervening parcels along a route through the grid. Thus, according to the various exemplary aspects, the concept of neighboring parcels and the fusion routing protocol generalize naturally to any trap architecture in which parcels can be selectively merged with adjacent parcels for gate operations, whether the parcels are arranged in a one-dimensional chain, a two-dimensional grid, or any other topology.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), Blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of performing quantum operations in a quantum system, comprising:
a) providing a trap comprising a plurality of parcels of atomic qubits, wherein the plurality of parcels includes a first parcel, a distant parcel that is not neighboring to the first parcel, and at least one intervening parcel;
b) configuring a shared Bell state between at least one atomic qubit of each parcel of each pair of neighboring parcels in the trap;
c) in each intervening parcel including two atomic qubits having a shared Bell state with an atomic qubit of a neighboring parcel, configuring a shared Bell state between the two atomic qubits; and
d) generating a fused resource-state between an atomic qubit of the first parcel and an atomic qubit of the distant parcel.

2. The method according to claim 1, further comprising maintaining the fused resource-state.

3. The method according to claim 1, wherein the trap comprises one intervening parcel positioned neighboring to each of the first parcel and the distant parcel.

4. The method according to claim 1, wherein the trap comprises a plurality of intervening parcels.

5. The method according to claim 1, further comprising configuring an atomic qubit of a further trap to share a Bell state with the distant atomic qubit of the distant parcel.

6. The method according to claim 1, wherein the Bell states are configured by a Mølmer–Sørensen gate scheme.

7. The method according to claim 1, wherein generating the fused resource-state between the first atomic qubit and the distant atomic qubit comprises two layers of gates.

8. The method according to claim 1, wherein steps c) and d) are simultaneous.

9. A quantum system configured to perform quantum operations, comprising:
a trap comprising a plurality of parcels of atomic qubits, wherein the plurality of parcels includes a first parcel, a distant parcel that is not neighboring to the first parcel, and at least one intervening parcel; and
an optical controller configured to:
a) configure a shared Bell state between at least one atomic qubit of each parcel of each pair of neighboring parcels in the trap;
b) in each intervening parcel including two atomic qubits having a shared Bell state with an atomic qubit of a neighboring parcel, configure a shared Bell state between the two atomic qubits; and
c) generate a fused resource-state between an atomic qubit of the first parcel and an atomic qubit of the distant parcel.

10. The quantum system according to claim 9, wherein the optical controller is further configured to maintain the fused resource-state.

11. The quantum system according to claim 9, wherein the trap comprises one intervening parcel positioned neighboring to each of the first parcel and the distant parcel.

12. The quantum system according to claim 9, wherein the trap comprises a plurality of intervening parcels.

13. The quantum system according to claim 12, wherein the optical controller is configured to implement a copy of the shared Bell state between the atomic qubit of an intervening parcel of the plurality of intervening parcels to the first parcel and a distant atomic qubit of a distant parcel.

14. The quantum system according to claim 13, wherein the optical controller is configured to implement the copy of the shared Bell state further by configuring a copy of the shared Bell state between an atomic qubit of each the plurality of intervening parcels.

15. The quantum system according to claim 9, wherein the optical controller is further configured to configure an atomic qubit of a further trap to share a Bell state with the distant atomic qubit of the distant parcel.

16. The quantum system according to claim 9, wherein the optical controller is further configured to implement the Bell states by a Mølmer–Sørensen gate scheme.

17. The quantum system according to claim 9, wherein the optical controller is configured to generate the fused resource-state between the first atomic qubit and the distant atomic qubit by using two layers of gates.

18. The quantum system according to claim 9, wherein the optical controller is configured to measure the Bell state of the atomic qubits of the at least one intervening parcel.
